(19) United States
(12) Patent Application Publication
(10) Pub. No.: US 2021/0122673 A1
(43) Pub. Date: Apr. 29, 2021

(54) THROUGH-GLASS VIA HOLE FORMATION METHOD

(71) Applicants: BSP CO., LTD., Anyang-si (KR); JOONGWOO M-TECH CO., LTD., Anyang-si (KR)

(72) Inventors: Hong Jin PARK, Anyang-si (KR); Sung Soo PARK, Anyang-si (KR)

(73) Assignees: BSP CO., LTD., Anyang-si, Gyeonggi-do (KR); JOONGWOO M-TECH CO., LTD., Ansan-si, Gyeonggi-do (KR)

(21) Appl. No.: 17/000,381

(22) Filed: Aug. 24, 2020

(30) Foreign Application Priority Data
Oct. 25, 2019 (KR) 10-2019-0133690

(51) Int. Cl. C03C 23/00; B23K 26/384; C03C 15/00

(52) U.S. Cl. CPC C03C 23/0025; B23K 2103/54; C03C 15/00; B23K 26/384

(57) ABSTRACT

A through-glass via hole formation method, includes: an internal deformation region formation step in which an internal deformation region is formed inside a glass substrate at a predetermined distance from a surface of the glass substrate; a surface etching step in which the glass substrate is thinned by immersing the glass substrate in an etching solution such that a portion of the surface of the glass substrate, at which the internal deformation region is not formed, is etched and removed at a first etching rate; and a through-glass via hole formation step in which, with the glass substrate immersed in the etching solution, the internal deformation region is etched and removed at a second etching rate higher than the first etching rate such that a through-glass via hole is formed in the glass substrate along the internal deformation region.

### FIELD

The present invention relates to a through-glass via hole formation method and, more particularly, to a through-glass via hole formation method which can form micro via holes through a glass substrate.

### BACKGROUND

A protective cover panel used in smartphones and the like is manufactured using a glass substrate. In order to provide speaker holes or button holes to the protective cover panel, it is necessary to form via holes through the glass substrate.

In order to form such through-glass via holes, laser drilling through irradiation with a laser beam, chemical etching using photolithography, and the like are commonly used.

Laser drilling has drawbacks of: difficulty in forming clean via holes; variation in via hole shape depending on what type of laser source is used; and difficulty in precisely machining micro via holes having a diameter of 10 μm or less. In addition, since laser drilling is a time consuming process in which multiple via holes are machined one by one, the process cost increases in proportion to increase in number of via holes to be machined. Further, there is a problem of deterioration in durability of via holes due to cracks occurring during machining.

Chemical etching requires high-precision photolithography equipment depending on the sizes of via holes, has difficulty in controlling via hole size since a via hole has a larger diameter at an upper portion than at a lower portion due to a taper angle created during processing, and has difficulty in precisely machining micro via holes having a diameter of 10 μm or less.

### RELATED LITERATURE

### Patent Document

(Patent Document 1) Korean Patent Publication No. 2007-0034765 (published on Mar. 29, 2007)

### SUMMARY

Embodiments of the present invention have been conceived to solve such a problem in the art and it is an aspect of the present invention to provide a through-glass via hole formation method which can improve surface quality of a through-glass via hole while achieving both formation of the through-glass via hole and thinning of a glass substrate through a process in which an internal deformation region is formed inside the glass substrate through irradiation with a laser beam, followed by immersing the glass substrate in an etching solution to form the through-glass via hole.

In accordance with an aspect of the present invention, a through-glass via hole formation method includes: an internal deformation region formation step in which an internal deformation region is formed inside a glass substrate at a predetermined distance from a surface of the glass substrate by irradiating the glass substrate with a laser beam at an intensity not exceeding an ablation threshold of the glass substrate; a surface etching step in which the glass substrate is thinned by immersing the glass substrate in an etching solution such that a portion of the surface of the glass substrate, at which the internal deformation region is not formed, is etched and removed at a first etching rate; and a through-glass via hole formation step in which, with the glass substrate immersed in the etching solution, the internal deformation region is etched and removed at a second etching rate higher than the first etching rate such that a through-glass via hole is formed in the glass substrate along the internal deformation region.

A thickness of the surface portion of the glass substrate removed in the surface etching step may be smaller than a thickness of a portion with the internal deformation region formed thereon, which is removed in the through-glass via hole formation step.

In the internal deformation region formation step, phase transition from an a-phase to a β-phase may occur in a region inside the glass substrate corresponding to the internal deformation region.

In the internal deformation region formation step, the internal deformation region M may be formed by inducing phase transition of a region inside the glass substrate ranging from an upper end of the internal deformation region to a lower end thereof without moving a focus of the laser beam.

The laser beam may be in the form of a Bessel beam corresponding in length to the internal deformation region.

In the internal deformation region formation step, the internal deformation region may be formed by inducing phase transition of a region inside the glass substrate corresponding to the internal deformation region while continuously moving a focus of the laser beam from an upper end of the region to a lower end thereof.

In the internal deformation region formation step, the internal deformation region may be formed in a closed curve shape inside the glass substrate by sequentially moving the laser beam along a virtual circular moving line having a smaller diameter than the through-glass via hole, and, in the through-glass via hole formation step, a region of the glass substrate located inside the internal deformation region and the virtual circular moving line may be removed to form the through-glass via hole in the glass substrate.

A through-glass via hole formation method according to the present invention can improve surface quality of a through-glass via hole while achieving both formation of the through-glass via hole and thinning of a glass substrate

In addition, the through-glass via hole formation method according to the present invention can prevent contamination of a surface of a glass substrate.

Further, the through-glass via hole formation method according to the present invention can reduce the time required for the overall thinning and through-glass via hole formation process.

Moreover, the through-glass via hole formation method according to the present invention can be compatible with a wide range of sizes of through-glass via holes.

### DRAWINGS

FIG. 1 is a flowchart of a through-glass via hole formation method according to one embodiment of the present invention.

FIG. 2 is a schematic view illustrating the through-glass via hole formation method of FIG. 1.

FIG. 3 is a view illustrating an internal deformation region formation step of the through-glass via hole formation method of FIG. 1.

FIG. 4 is a view illustrating an internal deformation region formation step of a through-glass via hole formation method according to another embodiment of the present invention.

FIG. 5 is an image showing contamination of a surface of a glass substrate upon forming a deformation region over the entire region inside the glass substrate.

### DETAILED DESCRIPTION

Hereinafter, embodiments of a through-glass via hole formation method according to the present invention will be described with reference to the accompanying drawings.

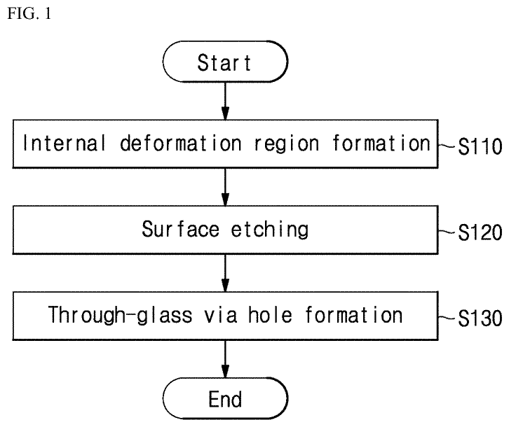

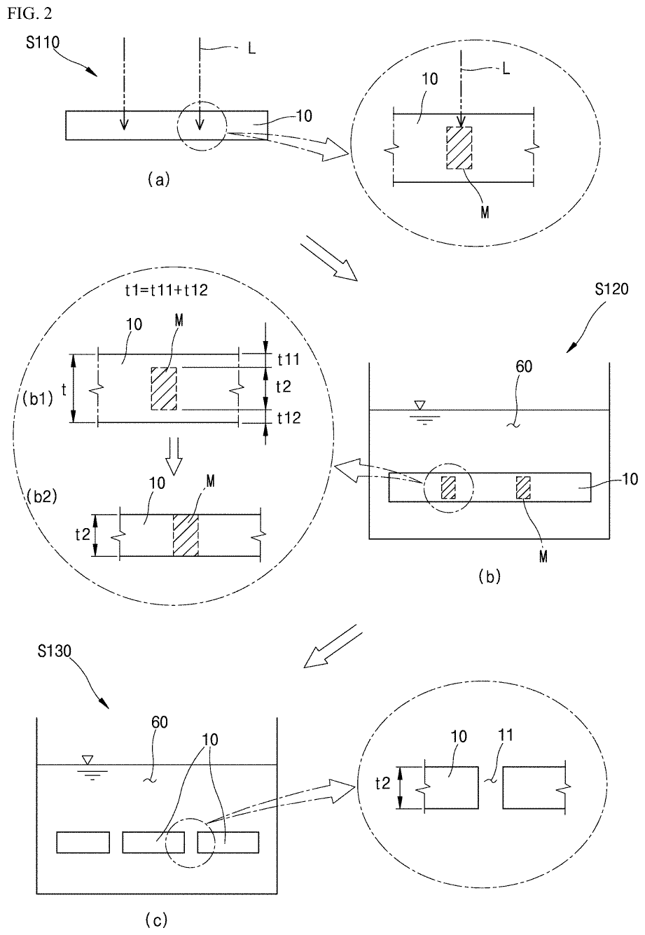

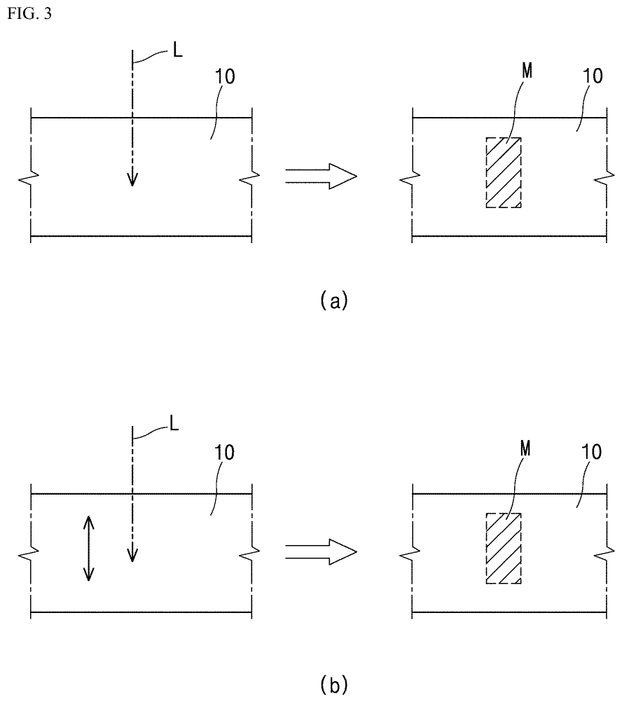

FIG. 1 is a flowchart of a through-glass via hole formation method according to one embodiment of the present invention, FIG. 2 is a schematic view illustrating the through-glass via hole formation method of FIG. 1, and FIG. 3 is a view illustrating an internal deformation region formation step of the through-glass via hole formation method of FIG. 1.

Referring to FIG. 1 to FIG. 3, a through-glass via hole formation method according to this embodiment is used to form micro via holes through a glass substrate and includes an internal deformation region formation step S110, a surface etching step S120, and a through-glass via hole formation step S130.

In the internal deformation region formation step S110, a hole-shaped internal deformation region M is formed by irradiating a glass substrate 10 with a laser beam L at an intensity not exceeding an ablation threshold of the glass substrate 10.

As the laser beam L radiated to the glass substrate 10 in the internal deformation region formation step S110, an ultrashort laser beam including a picosecond-pulse laser beam and a femtosecond-pulse laser beam may be used.

Upon irradiation of the glass substrate 10 with the picosecond-pulse laser beam or the femtosecond-pulse laser beam, no melt layers are formed in regions other than an irradiated region and any substrate material around the irradiated region does not undergo alteration. That is, irradiation with the picosecond-pulse laser beam or the femtosecond-pulse laser beam allows thermal energy to be effectively applied only to the irradiated region, thereby allowing the internal deformation region M to be clearly distinct from the other portions of the glass substrate 10.

Referring to FIG. 2(a), the internal deformation region M according to this embodiment is formed inside the glass substrate 10 at a predetermined distance from a surface of the glass substrate 10. Preferably, the internal deformation region M is formed inside the glass substrate 10 to be separated a predetermined distance from an upper surface of the glass substrate 10 and separated a predetermined distance from a lower surface of the glass substrate 10.

Upon irradiation of the glass substrate 10 with the laser beam L, a region irradiated with the laser beam L may undergo phase transition from an α-phase to a β-phase, whereby the internal deformation region M is formed.

In a region inside the glass substrate corresponding to the internal deformation region M, permanent physicochemical structural deformation occurs by a nonlinear photoionization mechanism induced by the ultrashort laser beam. A region in which the laser beam L is focused becomes rich in Si and dense and undergoes alteration in index of refraction and the like.

The internal deformation region M formed through irradiation with the ultrashort laser beam may be etched by an alkaline or acidic chemical solution 20 to 300 times as fast as the other regions of the glass substrate 10, which do not undergo deformation. Here, a rate at which the internal deformation region is etched may be adjusted by various parameters, such as laser intensity, pulse duration, repetition rate, wavelength, focal length, scan rate, and concentration of the chemical solution.

In one embodiment, the internal deformation region M may be formed by inducing phase transition of a region inside the glass substrate ranging from an upper end of the internal deformation region M to a lower end thereof without moving a focus of the laser beam, as shown in FIG. 3(a).

Here, the laser beam L is preferably in the form of a Bessel beam corresponding in length to the internal deformation region M.

In general, a laser beam has an intensity distribution in which a maximum intensity is located in the vicinity of the focus in a thickness direction of the glass substrate 10 and the level of intensity decreases away from the focus. That is, it is difficult to maintain a constant level of intensity over a predetermined length in the thickness direction of the glass substrate 10.

Use of a convex axicon lens allows formation of a Bessel beam that can maintain a constant level of intensity over a desired length in the thickness direction of the glass substrate 10. Here, a length over which the intensity of the Bessel beam is maintained at a constant level may be adjusted by varying the angle of a conical shape of a light-exit surface of the convex axicon lens.

In this embodiment, the internal deformation region M may be formed through irradiation with a Bessel beam having a constant level of intensity over a length corresponding to the length of the internal deformation region M.

In another embodiment, the focus of the laser beam L may be continuously moved from an upper end of a region inside the glass substrate corresponding to the internal deformation region M to a lower end of the region, as shown in FIG. 3(b). That is, the internal deformation region M may be formed by inducing phase transition of the entire region corresponding to the internal deformation region M while moving the focus of the laser beam in the thickness direction of the glass substrate 10.

In the surface etching step S120, the glass substrate 10 is thinned by immersing the glass substrate 10 in an etching solution 60 such that a portion of the surface of the glass substrate, at which the internal deformation region M is not formed, is etched and removed at a first etching rate.

The etching solution 60 used in the surface etching step S120 and the through-glass via hole formation step S130 described below may be a chemical etching solution, such as fluorine (HF), nitric acid (HNO₃), or potassium hydroxide (KOH).

Referring to FIG. 2(b), upon immersing the glass substrate 10 in the etching solution 60 in the surface etching step S120, the thickness of the glass substrate 10 is reduced. That is, with removal of a portion corresponding to a first thickness t1 in the surface etching step S120, the thickness of the glass substrate is changed from a pre-surface etching thickness t to a post-surface etching thickness t2.

Here, when the thicknesses of non-deformed portions of the glass substrate 10 above and below the internal deformation region M are t11 and t12, respectively, the first thickness t1, that is, the thickness of a portion of the glass substrate 10 which is removed in the surface etching step S120 means the sum of t11 and t12.

As the glass substrate 10 is thinned to the thickness t2 through the surface etching step S120, the internal deformation region M formed inside the glass substrate 10 contacts the etching solution 60.

In the through-glass via hole formation step S130, with the glass substrate 10 immersed in the etching solution 60, the internal deformation region M is etched and removed at a second etching rate higher than the first etching rate, whereby a through-glass via hole 11 is formed in the glass substrate 10 along the internal deformation region M.

Upon immersing the glass substrate 10 in the etching solution 60, the second etching rate at which a portion (β-phase) of the glass substrate 10 having the internal deformation region M thereon is etched may be about 100 times or more the first etching rate at which the other portions (α-phase) are etched.

Accordingly, upon immersing the glass substrate 10 with the internal deformation region M formed therein in the etching solution 60, the portion having the internal deformation region M formed thereon is mainly etched and the other portions are hardly etched during the through-glass via hole formation step S130. Accordingly, the through-glass via hole 11 is formed in the glass substrate 10 along the internal deformation region M as the portion with the internal deformation region M formed thereon is etched and removed.

A typical through-glass via hole formation method based on chemical dissolution using photoresist forms a through-glass via hole with a large taper angle, whereas a through-glass via hole formation method as in the present invention, in which a through-glass via hole is formed by etching an internal deformation region M formed through irradiation with a focused ultrashort laser beam, can form a through-glass via hole with a taper angle close to 0 degrees. In addition, the through-glass via hole 11 formed by the method according to the present invention can have a clean surface without crack marks.

Preferably, the first thickness t1, that is, the thickness of a portion of the surface of the glass substrate 10, which is removed in the surface etching step S120 according to this embodiment, is smaller than the second thickness, that is, the thickness of a portion with the internal deformation region M formed thereon, which is removed in the through-glass via hole formation step S130. Here, the second thickness t2 means the thickness of the internal deformation region M, which is removed by the etching solution 60 in the through-glass via hole formation step S130, and is substantially the same as the thickness of the glass substrate 10, from which a portion of the surface has been removed through the surface etching step S120.

Since the first etching rate at which the glass substrate in the α-phase is etched is much lower than the second etching rate at which the glass substrate in the β-phase is etched, it is possible to reduce the time required for the overall thinning and through-glass via hole formation process by allowing a portion in the α-phase (a portion of the surface of the glass substrate 10) to have a smaller thickness than a portion in the β-phase (a portion with the internal deformation region M formed thereon).

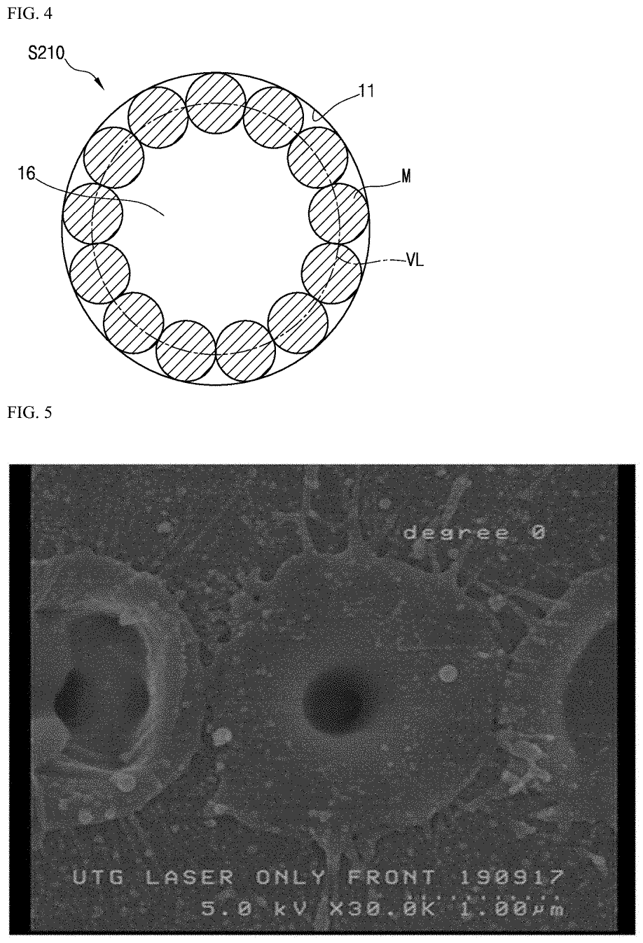

FIG. 4 is a view illustrating an internal deformation region formation step of a through-glass via hole formation method according to another embodiment of the present invention.

When the diameter of a through-glass via hole to be formed is relatively large (for example, 20 μm or more), it is difficult to form the through-glass via hole 11 by one shot of the laser beam L, as shown in FIG. 2, since there is a limitation in increasing the focal diameter of the laser beam L.

Accordingly, in the internal deformation region formation step S210 according to this embodiment, the internal deformation region (M) is formed in a closed curve shape inside the glass substrate 10 by sequentially moving the laser beam L along a virtual circular moving line VL having a smaller diameter than the through-glass via hole 11.

Here, since a certain area is occupied by the internal deformation region M, a circumscribed circle of the internal deformation region M has substantially the same diameter as the through-glass via hole 11 which will be formed.

When the internal deformation region M is continuously formed inside the glass substrate 10, in the through-glass via hole formation step according to this embodiment, a region 16 inside the internal deformation regions M and the virtual moving line VL is removed, thereby allowing the through-glass via hole 11 to be formed in the glass substrate 10.

Here, the region 16 inside the virtual circular moving line VL corresponds to a portion at which the internal deformation region M is not formed. The region 16 inside the virtual circular moving line VL falls off of the glass substrate, which is a base material, with removal of the internal deformation regions M, rather than being removed by etching.

The through-glass via hole formation method according to the present invention can improve surface quality of a through-glass via hole while achieving both formation of the through-glass via hole and thinning of a glass substrate, through a process in which an internal deformation region is formed inside the glass substrate through irradiation with a laser beam, followed by immersing the glass substrate in an etching solution to form the through-glass via hole.

FIG. 5 is an image showing contamination of a surface of a glass substrate upon forming a deformation region over the entire region inside the glass substrate.

Referring to FIG. 5, when a deformation region in the β-phase is formed across the entire thickness of the glass substrate 10, a glass substrate material melted by a laser beam in the step of forming the deformation region can be released onto the surface of the glass substrate 10, causing contamination of the glass substrate 10.

However, when the internal deformation region M is formed inside the glass substrate 10, as in the present invention, non-deformed portions of the surface of the glass substrate above and below the internal deformation region M can prevent release of a melted glass substrate material from the inside of the glass substrate, thereby preventing contamination of the surface of the glass substrate 10.

Accordingly, the through-glass via hole formation method according to the present invention can prevent contamination of a surface of a glass substrate by forming an internal deformation region inside the glass substrate through irradiation with a laser beam, followed by etching the internal deformation region.

In addition, the through-glass via hole formation method according to the present invention can reduce the time required for the overall thinning and through-glass via hole formation process by allowing a portion in the α-phase to have a smaller thickness than a portion in the β-phase.

Further, the through-glass via hole formation method according to the present invention can be compatible with a wide range of sizes of through-glass via holes by forming an internal deformation region in a closed curve shape inside a glass substrate while sequentially moving a laser beam.

While certain embodiments have been described, it should be understood that these embodiments are presented by way of example only and are not intended to limit the scope of the present invention and the embodiments described herein may be embodied in a variety of other forms. In addition, it should be understood that various modifications, variations, and alterations can be made by those skilled in the art without departing from the spirit and scope of the present invention.

### LIST OF REFERENCE NUMERALS

10: Glass substrate

60: Etching solution

L: Laser beam

M: Internal deformation region

S110: Internal deformation region formation step

S120: Surface etching step

S130: Through-glass via hole formation step

What is claimed is:

1. A through-glass via hole formation method comprising:
an internal deformation region formation step in which an internal deformation region is formed inside a glass substrate at a predetermined distance from a surface of the glass substrate by irradiating the glass substrate with a laser beam at an intensity not exceeding an ablation threshold of the glass substrate;
a surface etching step in which the glass substrate is thinned by immersing the glass substrate in an etching solution such that a portion of the surface of the glass substrate, at which the internal deformation region is not formed, is etched and removed at a first etching rate; and
a through-glass via hole formation step in which, with the glass substrate immersed in the etching solution, the internal deformation region is etched and removed at a second etching rate higher than the first etching rate such that a through-glass via hole is formed in the glass substrate along the internal deformation region.

2. The through-glass via hole formation method according to claim 1, wherein a thickness of the portion of the surface of the glass substrate removed in the surface etching step is smaller than a thickness of a portion with the internal deformation region formed thereon, which is removed in the through-glass via hole formation step.

3. The through-glass via hole formation method according to claim 1, wherein, in the internal deformation region formation step, phase transition from an a-phase to a β-phase occurs in a region inside the glass substrate corresponding to the internal deformation region.

4. The through-glass via hole formation method according to claim 3, wherein, in the internal deformation region formation step, the internal deformation region is formed by inducing phase transition of a region inside the glass substrate ranging from an upper end of the internal deformation region to a lower end thereof without moving a focus of the laser beam.

5. The through-glass via hole formation method according to claim 4, wherein, the laser beam is in the form of a Bessel beam corresponding in length to the internal deformation region.

6. The through-glass via hole formation method according to claim 3, wherein, in the internal deformation region formation step, the internal deformation region is formed by inducing phase transition of a region inside the glass substrate corresponding to the internal deformation region while continuously moving a focus of the laser beam from an upper end of the region to a lower end thereof.

7. The through-glass via hole formation method according to claim 1, wherein, in the internal deformation region formation step, the internal deformation region is formed in a closed curve shape inside the glass substrate by sequentially moving the laser beam along a virtual circular moving line having a smaller diameter than the through-glass via hole, and, in the through-glass via hole formation step, a region of the glass substrate located inside the internal deformation region and the virtual circular moving line is removed to form the through-glass via hole in the glass substrate.
